(19) United States
(12) Patent Application Publication
(10) Pub. No.: US 2006/0080404 A1
(43) Pub. Date: Apr. 13, 2006

(54) Method and device for generating a mobile homepage in accordance with context related information

(76) Inventors: Knut Haber-Land-Schlosser, Bochum (DE); Udo Goertz, Bochum (DE); Matthias Luck, Dortmund (DE); Klaus Rateitschek, Bochum (DE); Reza Serafat, Bochum (DE); Wolfgang Theimer, Bochum (DE); Peter Weingart, Bochum (DE); Jakke Makela, Turku (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/517,018

(22) PCT Filed: Jun. 19, 2002
(86) PCT No.: PCT/IB02/02264

§ 371 Date: Jul. 25, 2005

(51) Int. Cl. G06F 15/16

(52) U.S. Cl. 709/218

(57) ABSTRACT

Disclosed is a method for handling and generating a mobile homepage of a mobile terminal device in accordance with context related information of said device. The method comprises the determination of context related information of said mobile terminal device, and the generation of said mobile homepage in accordance with said determined context related information. It is further disclosed a mobile terminal and a network device disclosed that are capable of handling mobile homepage according to the above mentioned methods.

The present invention relates to mobile electronic terminal devices being connectable to communication networks. It also relates to a method for providing information to a person trying to contact a mobile terminal device. It also relates to a method to increase the service provided to a person trying to contact said mobile electronic terminal device. More specifically the invention relates to the situation that the user of a mobile device offers a personal mobile homepage or webpage on his mobile terminal device. The term “homepage” may equally relate to any URL identifiable web address.

Assuming that the mobile device is equipped with sufficient storage capacity, there are good reasons to integrate a personal mobile homepage, i.e. mobile WEB server functionality into the mobile device itself. On the one hand this reduces costs for the user (no air traffic for updating the content) and enables the user to update the content during spare time at any place. On the other hand the remote user benefits from richer and up-to-date information, which will be provided during a rich call or during direct access, whenever he wishes to get it. This advantage is evening out the little drawback of having to pay for the delivered information.

Mobile electronic devices enable users to browse the internet, the WEB or other communication networks. Such well known devices such as the NOKIA™ Communicator™ or wireless communication enabled Personal Digital Assistants (PDAs), Palm and Laptops, provide the possibility to use the internet with a mobile electronic terminal device.

The next step in development is not only to provide a user terminal in a mobile electronic device, but also a server to provide a homepage in a mobile electronic device. Such mobile integrated homepages are described in the U.S. Pat. No. 5,956,487 assigned to Hewlett Packard Company, Palo Alto, Calif. and in the European Patent Application EP 0 918 423 A2 assigned to NOKIA MOBILE PHONES LDT, Espoo (Fin). Both documents describe electronic devices providing a possibility to operate as a server. U.S. Pat. No. 5,956,487 describes to store a retrievable homepage on the electronic device, and EP 0918 423 deals with mobile electronic devices.

The US document is based on a method to integrate a homepage into devices to enable a user to retrieve device status specific information, e.g. of a printer in a network by using an internet browser. In the European Patent Application, a user can choose between an internet hypertext markup language (HTML) homepage and a Wireless Markup Language (WML) homepage being retrievably stored.

A personal mobile homepage is defined as remotely accessible information (in HTML, XHTML, or other format, addressed via a ‘mobile’ URL) stored within a mobile device, which can be read with a WEB browser. The personal mobile homepage itself can contain links to other internal or external (mobile or fixed) WEB pages. This means that the mobile device will act as a WEB server. Remote access to the mobile homepage is possible, by direct access, just like a normal WEB page.

WEB pages in the fixed Internet have the drawback that they are often outdated. As WEB-pages in the internet are fixed, they need not reflect the current accessibility of a user or a user device.

All the above approaches for a mobile homepage have in common that they only transfer the well known server technology to mobile servers for the use with mobile terminal devices as mobile phones, or handheld computers.

So it is desirable to have a mobile electronic device enabling a user to provide and regularly update a mobile homepage.

It is further desirable to develop new possibilities to the owner of a personal mobile homepage as well as to personal mobile homepage users.

It is further desirable to improve existing and upcoming services, to be used in the context of mobile homepages, mobile electronic, and communication devices.

It is further desirable to provide a method and a device for supplying a personal mobile homepage having more convenience/comfort and opportunities to the user, than today.

The invention described herein refers to the situation that a user of a mobile device offers a mobile homepage. The content of the mobile homepage is stored in the device itself and can be configured according to device settings etc. In addition the homepage according to another embodiment is located outside the device, maybe in the server.

According to a first embodiment of the present invention, a method for adapting the content of a mobile homepage in accordance with context related information of a mobile terminal device is provided. The method comprises the determining of information related to the context of said mobile terminal device, and generating or adapting a mobile homepage in accordance with said determined information. Basically the invention describes methods for the dynamic generation of a mobile homepage.

In a basic embodiment of the invention an automated dynamic update of said mobile homepage is performed. So the homepage can be generated in accordance with information such as position information, signal strength information, time information, or information related to environmental conditions of said mobile device the mobile homepage is stored on. So the mobile homepage can comprise information such as a small map indicating the actual position of the mobile terminal device, or other elements indicating e.g. actual weather conditions such as temperature, atmospheric pressure, and humidity.

The homepage can be generated in accordance with information related to conditions in the mobile terminal device e.g. remaining battery power, remaining memory to store messages, E-mails, actually stored music files and other internal conditions of said mobile device the mobile homepage is stored on. The method can be initiated if a change in the context of the mobile terminal device takes place, or can be initiated periodically by a timer. The homepage can be created in accordance with the present device status, so the homepage can comprise information about the current device settings as, e.g. activated mailboxes, activated silent mode, an activated day/night switch, and the like. If the mobile terminal device is configured, the content, user access etc. can be automatically aligned with the device profile, location or other context related information.

In another embodiment of the present invention the method further comprises evaluating said determined context related information, and generating said homepage in accordance with a result of said evaluation operation. The evaluation can comprise a presence list, or a VIP—(Very Important People) or “Buddy” list.

The mobile homepage can be configured in a way that the content is varied according to a buddy list, time, selected device profile, battery status, location of the user or other parameters, wherein the context related information is to be checked against data entries in a telephone list, a clock, a timer, and the like. The evaluating process can provide a kind of fuzzy logic relation to context related information like device status and context related information, if different context information would lead to conflicting rules for the generation of the homepage.

According to another embodiment of the present invention, the method further comprises a dispatching of a communication request. A dispatched communication request represents a change in the context related information, and can therefore be used to update or adapt the mobile homepage accordingly.

In another embodiment, the method further comprises receiving a communication request. The reception of a communication request can be used to initiate the method, so the homepage is only generated or adapted to the present context conditions, if a homepage is requested for downloading, or it can be expected that the homepage is to be requested for downloading. Additionally, a received communication request provides additional context information, such as the sender of the request, and the properties of the communication channel via the communication request was received. The mobile homepage can be generated according to the origin of the communication request, like in accordance with a buddy list or the present communication device status.

In another embodiment of the present invention said context related information comprise communication properties. The communication properties are related to a communication status of the mobile terminal device. The communication properties comprise information about the communication networks available or actually connected. The communication properties can comprise information like signal strength, signal to noise ratio, available bandwidth, available data transfer rates and other technical properties related to available data transfer. The communication properties can further comprise information referring to actually performed communication, like information about the partner of communication, actually used coding or encrypting methods.

In one embodiment of the method said communication request is a rich call. Rich calls can be used to bring the generated mobile homepage in connection with e.g. a phone call. The mobile homepage transfer can best be visualized by a comparison with the transmission and displaying of the phone number of a caller on a display of a mobile telephone, according to the use of rich calls the caller can transfer a whole mobile homepage instead of only a telephone number. The mobile homepage transfer can be used to display e.g. a picture of the caller on the display of the called device, or to generate a ringing tone related to the sender of the communication request.

In an embodiment of the present invention the method further comprises the transmission of said generated mobile homepage. The transmission can be initiated in response to a received communication request, or can be dispatched together with a communication request. The transmission of the generated homepage can be started as in conventional cases in response to a direct access, just like a normal WEB page, as part of a rich call, as in the preceding description, or as a part of a presence feature. In case of a direct access, just like a normal WEB page the universal resource locator (URL) identifier can be linked to the device or may be generated as a combination of a device identification and a SIM (Subscriber Identification Module), or only by a SIM identification. Device linked URLs are state of the art. The transmission of a homepage as a part of a presence feature, can be embodied by a mobile communication device, that responds to a communication request to a mobile terminal device in a silent mode by the transmission of the mobile homepage. This provides a homepage mailbox feature, wherein the transmitted homepage can be used equivalent to a text on an answering machine, and can be used similar to a voice message left on an answering machine. In such an embodiment, the Mail- or “Page-box” would inform a user of communication requests or attempts by providing the homepages instead of the phone numbers, E-mails or voice mails.

The method can further comprise the reception of information that is related to the origin of a communication request. This is the reception of an identification provided to identify the originator of a communication attempt. With this identification of the caller the homepage can be generated comprising special features like personal status or device profile, selective availability; representation of the user in an official and in a formal way, emotional, expressive and visual content, location, and the like.

In another embodiment said communication properties include an identification of an origin of said communication request. This includes the transmission of a self identification, in connection with a communication attempt. Thereby, a homepage generated according to the destination or addressee of said communication attempt can be transmitted in connection with the communication attempt. The transmitted homepage can be generated in accordance with context information, like addressee, estimated distance (determined by position information of the device and the position information of the addressee) and the like. The identification can be used to determine the technical properties of the origin (or addressee) of said communication request, so the resolution of the homepage generated can be chosen accordingly. When the origin of the communication request is a second generation mobile phone, the homepage need not be generated, in case of a 3^{rd} or more generation communication device a normal average resolution and format fitting a standard telephone display can be chosen. In case of a communicator or a computer, the homepage can be generated and transferred with a maximum resolution and data content.

In one embodiment of the method said communication property comprises information concerning the communication connection of said mobile terminal device. Typically, the information is related to signal strength, location and the like. The information can further be related to a bandwidth or data rate the communication channel is providing. This is important as the device can chose the data content of the mobile homepage according to an actually present transfer connections or conditions. In case of a low data rate connection the data content can be reduced. In case of a stable UMTS connection, the resolution of graphics in the homepage can be increased.

In another embodiment, said communication property comprises information according to a communicative state of said mobile terminal device. The operative state of a mobile telecommunication device comprises settings like phone profile: common/meeting/silent/work/home/TV/recording/vacation and the like. The communicative state can be used as a part of a presence feature provided by the mobile device. So the generated Homepage can comprise information like “Sorry Bob, I'm in a meeting, but will be calling you ASAP.”, in case Bob calls, and the mobile terminal device is in a silent mode. This feature can be used to generate and transmit a homepage in case a communication request is received during another communication is in process. It may be noted that with disclosed steps an embodiment of the present method can also include detecting low battery power, the evaluation of this information, and the transmission of the actual homepage to a server, as it can be expected that the mobile terminal device will stop operating in near future.

According to another aspect of the present invention a method for automatically rerouting a communication request directed to a mobile device is provided. The method, comprises receiving a communication request for connection to said mobile device, detecting if said mobile device is connectable, and in case said mobile device is not connectable, rerouting said communication request to a homepage which is preferably a non-mobile homepage or webpage. This method can be executed in the mobile device itself, e.g. when a communication is request that can actually not be provided, e.g. because the mobile phone is in a silent mode, the mobile homepage is in the process of being updated or the like. The same method can be executed on a communication server such as a mobile switching center (MSC), or a Gateway MSC, to provide at least a homepage of a user, if the requested communication can not be provided. With links to fixed Internet pages an access to profile independent content can be provided, even if the mobile terminal is turned off.

According to another aspect of the present invention a method for automatically updating a homepage of a server according to a mobile homepage is provided. The homepage can be a personal homepage, and the server can be an internet server, or an integrated-service server. The method comprises uploading a mobile homepage of said mobile terminal device, and storing said uploaded mobile homepage on said server. It may be noted that even additional information can be uploaded together with said mobile homepage. Thereby the mobile homepage can be provided to a user even if the mobile device is off. The upload can be activated independently of the actually used homepage.

In another embodiment of the method said uploading is initiated when it is detected that attainability of the mobile terminal is expected to be reduced. The upload can be initiated when it can be estimated that the mobile terminal device is going to loose contact to the base station or the communication network (in case signal strength is decreasing, and the contact is estimated to be interrupted within a few mins or seconds). In case the mobile terminal device receives a “power down” signal from the user, it can mirror an “unattainable-” homepage to the communication server and then can power down. So it is guaranteed, that a communication request can be responded with a link to the most actual version of a mobile homepage. The download can also be initiated periodically, or only in the case a change in the mobile homepage has been detected, or a timer based solution downloading said mobile homepage at least once a week or once a month.

In another embodiment of the present invention said homepage is a HTML homepage. Other embodiments of the invention uses WML homepages. In other embodiments the invention can use cHTML, XHTML or the like for generating the homepage. It may further be noted that the Markup Language used for generating said homepage may be selected in dependence of detected context related information, e.g. is the requesting device a computer or a browser enabled phone.

According to another aspect of the present invention, a software tool capable of carrying out the methods of the preceding description is provided, which comprises program code means for performing all of the steps of the preceding description when said software tool is incorporated in a program which is run on a computer or a network device.

According to yet another aspect of the invention, a computer program is provided comprising program code means stored for carrying out the aforementioned methods of the preceding description when said computer program is run on a computer or a network device.

According to yet another aspect of the invention, a computer program product is provided comprising program code means stored on a computer readable medium for carrying out the method of the preceding description when said program product is run on a computer or a network device.

According to another aspect of the present invention a mobile terminal device is provided. The mobile terminal device comprises a server providing a server functionality to said mobile terminal device, and a storage for storing at least one homepage on said mobile terminal device. The mobile terminal device is characterized by a processor which is configured to determine context related information of said mobile terminal device, and is further configured to generate a homepage according to said determined context related information.

According to another embodiment of the invention, the mobile terminal device further comprises a component for evaluating said context related information. Said component can be a processor configured by software for evaluating determined context information. The evaluation can be used to decide if and how said homepage is to be generated.

In another embodiment the mobile terminal device further comprises a processor that is configured to connect said mobile terminal to a server, and that is configured to transfer the contents of a mobile homepage of said mobile terminal device, to said server. Such a mobile terminal device is capable of automatically transferring a mobile homepage to a server so that a server can provide the homepage in case the mobile device is actually not available.

In another embodiment said processor is further configured to detect a change in the attainability status of said mobile terminal device, and configured to initiate said transfer of the mobile homepage content, in case a decrease in the attainability is detected. The attainability is one of the context information detectable by said processor. An actual or expected change of the attainability status can be used to initiate the transfer, as described in the description of the respective method.

According to another aspect of the present invention, a network server is provided that can be connected to a mobile terminal device. The network server comprises a storage for storing at least one homepage, and is characterized by a processor configured for downloading a mobile homepage from said mobile terminal device, and a storage being connected to said processor for storing said downloaded homepage. The server can be incorporated in a mobile switching center (MSC)of a mobile communication network or the like network devices.

According to another embodiment of the present invention the network server further comprises a processor being configured to detect a change in the attainability status of said mobile terminal device, and being further configured to initiate a download of a mobile homepage, in case a decrease of the attainability of said mobile terminal is detected. In this configuration the server acts like a watchdog monitoring the attainability state of said mobile terminal device to request the newest version of the mobile homepage, it is probable that the device will no longer be attainable. The server can be incorporated in a mobile switching center (MSC), or a Gateway MSC.

In the following, the invention will be described in detail by referring to the enclosed drawings in which:

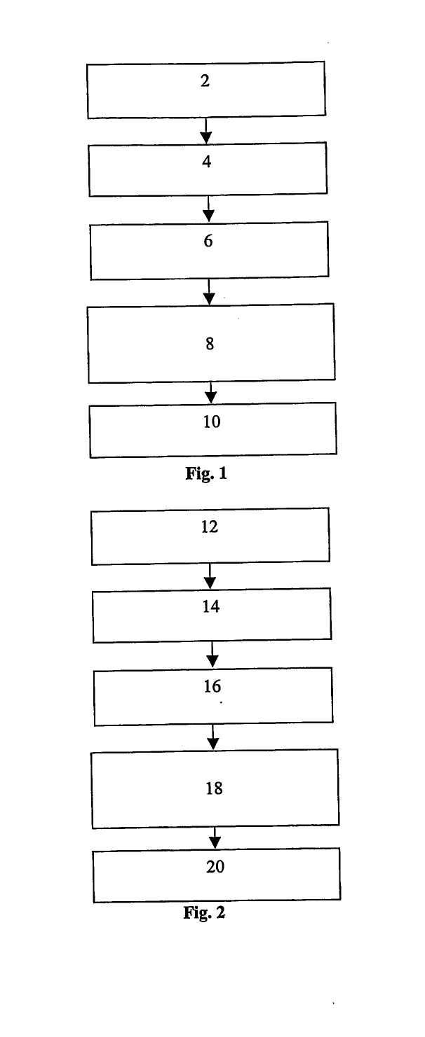

FIG. 1 is a flowchart of a method of generating a mobile homepage in the area of mobile communication according to one aspect of the present invention,

FIG. 2 is an example of an embodiment of the evaluation of FIG. 1,

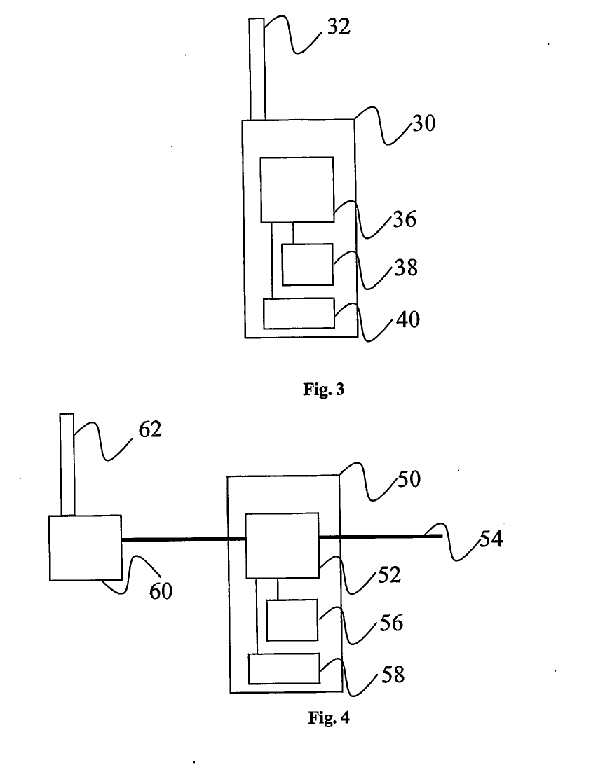

FIG. 3 is an example of an embodiment a mobile terminal device according to another aspect of the present invention, and

FIG. 4 is an example of an embodiment of a server according to another aspect of the present invention.

FIG. 1 is a flowchart of a method for generating a mobile homepage in the area of mobile communication according to one aspect of the present invention. The method starts with receiving a communication request in block 2. In this example, the communication request triggers the following determination 4 of context related information. Next, the context related information is evaluated 6. The evaluation of the information can be used to decide if a mobile homepage is to be generated or not, wherein this decision can be made on basis of information derived from said communication request. After evaluating different context related information it can be decided in which form the homepage can be generated. Based on the evaluation, the homepage can be generated accordingly in block 8. As an alternative to the generation, all possible homepages can be generated and stored directly after an update process, and are simply recalled, if a detected context information and evaluation demands a homepage. Finally, the homepage is transmitted 10 according the received communication request and said evaluated context information.

FIG. 2 is a detailed description of an embodiment of the element of the evaluation of FIG. 1. The evaluation process 6 element can be subdivided for example in five sub-evaluations. In the first sub-evaluation 12 the sender of the communication request is evaluated e.g. by using a buddy list, a colleague list or the like. As in the case of conventional telephones, a phone register can be used to generate evaluate features of the mobile homepage. For example a word of welcome can be selected according to the originator of the call. So in the case of an unknown caller a very formal word of welcome/homepage content can be selected, wherein the homepage generated for a buddy may even comprise ironic or funny elements such as jokes and funny icons, GIFs and the like. The first evaluating step is here only a more or less style related decision for the generation of the mobile homepage.

In the second sub-evaluation 14, the available bandwidth for the transmission of the homepage is determined and decides about the resolution or the maximum allowed amount of data in the homepage to be generated. In the second evaluation it is decided how many bits are allowed in the homepage to be generated.

In the third sub-evaluation the technical properties are taken into account. Typically this evaluation determines which format and which language is chosen for the generation of the homepage. If the device knows the addressee of the homepage, it can decide which format, and resolution would fit best to the device the homepage is to be transmitted to.

In the forth evaluation step, the context information related to the device itself is used for deciding how the homepage should be generated. As an example the actual mode of operation can be added to the homepage indicating, if the mobile terminal is in a sleep mode or if it is actually generating a ringing tone. More sophisticated mobile terminal devices may further add information about the location of the mobile phone, or can comprise information about the environment like temperature, humidity and atmospheric pressure.

In the fifth evaluation all the aforementioned sub evaluations are evaluated to determine the form of the homepage to be generated. This information is transferred to a processor in the mobile terminal device to generate an appropriate homepage from stored information and from context related information.

As can be seen from the description of FIGS. 1 and 2, personal mobile homepages can be much more refined than the network-based solutions available today, providing more convenience/comfort and opportunities to the user.

A remote access to the mobile homepage is possible, but not restricted to, direct access, just like a normal WEB page, as part of a rich call, or as part of the presence feature

The properties of the personal mobile homepage can be dependent from (but is not restricted to) the following features. The mobile homepage can be activated/deactivated for specified VIP/buddy lists. The mobile homepage can be configured in a way that the content varies according to buddy list, time, selected device profile, location of the user or other parameters. The mobile homepage can handle dynamic data, dependent from time (e.g. day/night switch), special events (e.g. reception of a certain phone call or message), location of the device etc. A personal mobile homepage agent could send a predefined notification to a calling party that additional information (the mobile homepage) is available, e.g. in the case that the device is in silent mode. The offer for the delivery of a mobile homepage may be indicated acoustically e.g. by an generated announcement like “for homepage please dial 9”. The mobile homepage can contain a reference to other WEB/WAP pages, either mobile or fixed, using Hyperlinks or the like.

For the outlined scenarios it is helpful if the mobile homepage can be very closely linked with the user's phonebook, the currently selected device setting like device profile and other mobile data, e.g. location. This gives the mobile homepage a mobility advantage against fixed Internet homepage solutions to achieve the same or even higher levels of functionality.

The user benefits from the described methods, as the user can update the content of the mobile homepage whenever he likes, without paying for air time. Another advantageous effect is that the user can define automated updates of the mobile homepage via device profiles, settings etc. The remote user needs only fetch the information he is interested at a certain time reducing unsuccessful communication attempts. The user can leave a message referring to the content of the mobile homepage. The provider of the communication network benefits from the fact that every communication attempt includes the transfer of data which can be accounted.

The invention provides a cost efficient and highly configurable homepage solution to users of mobile devices. The mobile homepages can reflect the current accessibility of the user.

The “custom generated” mobile homepage can take conditions in account that are not accessible by standard homepages. In case of 3GPP, features can be used to customize a mobile homepage comprising for example:

personal status or device profile: available, in meeting, on holiday etc.,

a representation of self, emotional, expressive and visual content, etc.,

terminal status: out of coverage, engaged, switched off, location or context, roaming abroad, in this locality, in bus

terminal capabilities: i.e. supports SMS, MMS, IM

preferred contact method, and other features.

This invention provides new possibilities and comfort to the mobile homepage owner as well as to mobile homepage users, which haven't been offered earlier. All current solutions cover the area of the mobile homepages only partly.

FIG. 3 is an example of an embodiment a mobile terminal device according to an aspect of the present invention. In the figure, the mobile terminal device is a mobile telephone 30 with an antenna 32 for connecting said mobile phone 30 to a communication network (not shown). The mobile telephone comprises a server 38 to provides a server functionality to said mobile terminal device. The mobile telephone 30 further has a storage 36, for storing at least one homepage on said mobile terminal device. The mobile telephone 30 further comprises a processor 40 configured to determine context related information of said mobile telephone, and to generate a homepage according to said determined context related information.

FIG. 4 is an example of an embodiment of a server according to another aspect of the present invention. The server 50 is connected to a communication network 54 such as the internet. The server is further connected to a MSC 60 (mobile switching center), for providing a wireless connection to a mobile terminal device of FIG. 3 via antenna 62. The server 50 further comprises a storage 56 for storing at least one homepage. With this basic configuration the network device can be operated as a convention al GMSC a Gateway MSC for providing Email to SMS transfer and the like. To provide an operability according to the present invention the server 50 further comprises a processor 58 configured for downloading a mobile homepage from a mobile terminal device via the mobile communication system indicated by the MSC 60. The server further requires a storage being connected to said processor for storing said homepage downloaded from the mobile terminal device.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

Abbreviations:

3GPP—3^{rd} Generation Partnership Project
cHTML—compact HTML
HTML—HyperText Markup Language
IM—Instant Messaging
MMS—Multimedia Message Service
MSC Mobile Switching Center
SMS—Short Message Service
URL—Universal Resource Locator
WEB World Wide Web, a part of the internet
WML Wireless Markup Language
XHTML—extensible HTML

1. A method for automatically adapting the contents of a mobile homepage of a mobile telephone device in accordance with context related information of said device, comprising
automatically determining context related information of said mobile telephone device, and
automatically adapting said mobile homepage in accordance with said determined context related information.

2. The method according to claim 1, further comprising evaluating said determined context related information and adapting said homepage in accordance with a result of said evaluation operation.

3. The method according to claim 1, further comprising dispatching a communication request.

4. The method according to claim 1, further comprising receiving a communication request.

5. The method according to claim 3, wherein said communication request is a multimedia call.

6. The method according to claim 1, wherein said context related information comprises communication properties.

7. The method according to claim 1, further comprising transmitting of said generated mobile homepage.

8. The method according to claim 1, further comprising receiving an identification of the originator of a communication attempt.

9. The method according to claim 6, wherein said communication properties comprise information about a communication connection of said mobile telephone device such as signal strength, location bandwidth or data rate.

10. The method according to claim 6, wherein said communication properties comprise information according to a communicative state of said mobile telephone device.

11. The method according to claim 1, comprising
downloading the contents of a mobile homepage of said mobile telephone device,
storing said downloaded mobile homepage on a server, said server containing a homepage, thereby automatically updating said homepage on said server according to said mobile homepage of said mobile telephone device.

12. The method according to claim 11, wherein said downloading is initiated when it is detected that the attainability of the mobile telephone is expected to be reduced.

13. The method according to claim 1, comprising
receiving a communication request for a connection to said mobile device,
detecting if said mobile device is connectable, and
in case said mobile device is not connectable, rerouting said communication request to a homepage downloaded from said mobile telephone device said communication request has been directed to.

14. The method according to claim 1, wherein said homepage is an HTML or XHTML homepage.

15. The method according to claim 1, wherein said homepage is a WML homepage.

16. A software tool comprising program code means for carrying out the steps claim 1 when said program is run on a network device or a mobile telephone device.

17. A computer program comprising program code means for carrying out the method of claim 1 when said program is run on a computer or network device.

18. A computer program product comprising program code means stored on a computer readable medium for carrying out the method of claim 1 when said program is run on a network device or a mobile telephone device.

19. A mobile telephone device, comprising:
a server that provides a server functionality to said mobile telephone device,
a storage for storing at least one homepage on said mobile telephone device,
characterized by
a processor configured to determine context related information of said mobile telephone device and to adapt said homepage according to said determined context related information.

20. The mobile telephone device according to claim 19, further comprising at least one component for evaluating said context related information.

21. The mobile telephone device according to claim 19, further comprising
a processor configured to connect said mobile telephone to a server, and configured to transfer the contents of a mobile homepage of said mobile telephone device to said server.

22. The mobile telephone device according to claim 21, further comprising a processor configured to detect an attainability status of said mobile telephone device and to initiate said transfer of the mobile homepage contents, in case a decreased attainability status is detected.

23. A network server connectable to a mobile telephone device, comprising:
a storage for storing at least one homepage,
characterized by
a processor configured for downloading a mobile homepage from said mobile telephone device, and
a storage being connected to said processor for storing said downloaded homepage.

24. The network server according to claim 23, further comprising a processor configured to detect an attainability status of said mobile telephone device, and being configured to initiate said download of the mobile homepage, in case a decreased attainability status of said mobile telephone is detected.
